(19) United States
(12) Patent Application Publication
(10) Pub. No.: US 2014/0198838 A1
(43) Pub. Date: Jul. 17, 2014

(54) TECHNIQUES FOR MANAGING VIDEO STREAMING

(71) Applicants: Nathan R. Andrysco, Chandler, AZ (US); Amit Puntambekar, Fremont, CA (US); Devadutta Ghat, Sunnyvale, CA (US)

(72) Inventors: Nathan R. Andrysco, Chandler, AZ (US); Amit Puntambekar, Fremont, CA (US); Devadutta Ghat, Sunnyvale, CA (US)

(21) Appl. No.: 14/039,773

(22) Filed: Sep. 27, 2013

Related U.S. Application Data
(60) Provisional application No. 61/752,713, filed on Jan. 15, 2013.

(51) Int. Cl. H04N 7/26

(52) U.S. Cl. CPC H04N 19/00387
USPC 375/240.1

(57) ABSTRACT

An apparatus may include a memory to store a video frame, a processor circuit and a selective encoding component for execution on the processor to perform selective encoding of the video frame, the selective encoding to classify the video frame into a primary object region and a background region, and encode the primary object region at a first quality level and the background region at a background quality level, the first quality level to comprise a higher quality level than the background quality level.

### RELATED APPLICATIONS

This application claims priority to U.S. Provisional Patent Application 61/752,713 filed Jan. 15, 2013 and incorporated by reference herein in its entirety.

### TECHNICAL FIELD

Embodiments described herein generally relate to image processing and more particularly to video streaming.

### BACKGROUND

Streaming of video across communications networks such as the internet and mobile wireless networks has become ubiquitous as data storage capabilities, processor capabilities and communications infrastructure has improved. Applications such as live streaming of sports events, videoconferencing, and other real time streaming applications are becoming increasingly popular. In addition, video streaming of recorded content such as movies and user-generated video is also becoming increasingly popular.

Most such applications consume large bandwidth due to the large amount of data required to represent a video frame and the frame rate, which may exceed 24 frames per second. One technology trend that has been observed is that the use demand for video streaming is outpacing the growth in bandwidth in the data networks such as the internet and wireless networks. In addition, bandwidth over such networks may fluctuate in an unpredictable manner.

As a result of bandwidth limitations, video streaming applications may experience frame loss, buffering, or jitter during video streaming. On the other hand some present day applications may automatically lower the resolution of video content being streamed in response to a low bandwidth condition in order to reduce data rate. In all of these examples the video streaming application may fail to deliver an acceptable user experience during the video streaming.

It is with respect to these and other considerations that the present improvements have been needed.

### BRIEF DESCRIPTION OF THE DRAWINGS

FIG. 1 depicts one arrangement for streaming video according to various embodiments.

FIG. 2 shows an arrangement for operating an apparatus consistent with various embodiments.

FIG. 3 shows an arrangement for operating an apparatus consistent with additional embodiments.

FIG. 4 shows another arrangement for operating an apparatus consistent with additional embodiments.

FIG. 5 depicts one embodiment of a selective encoding component.

FIG. 6A to FIG. 6C depict one example of selective encoding of video for streaming consistent with the present embodiments.

FIGS. 7A-7E illustrate one example of generating a selectively encoded video stream according to further embodiments.

FIGS. 8A-8C depict a scenario of decoding of selectively encoded video content consistent with various embodiments.

FIG. 8D depicts an example of video frame decoding after non-selective encoding.

FIGS. 9A-9D illustrate an example of primary object regions and background regions.

FIGS. 10A to 10C depict one scenario of dynamic selective encoding of video streaming.

FIG. 11 depicts an exemplary first logic flow.

FIG. 12 depicts an exemplary second logic flow.

FIG. 13 illustrates one system embodiment.

FIG. 14 illustrates another system embodiment.

FIG. 15 illustrates an example device, arranged in accordance with an embodiment of the present disclosure.

### DETAILED DESCRIPTION

The present embodiments provide improved video streaming, and in particular enhance quality of streamed video images by selective encoding of objects of interest within a video. Such objects of interest may be classified as object regions whose image quality is to be preserved in a streamed video, while other portions of video frames that constitute the streamed video may be less important and may therefore be encoded differently than primary object regions. The terms “quality” and “image quality” are used herein synonymously to refer to the level of information content or resolution of a portion of a video frame either before encoding, during encoding, and after decoding of that portion. Thus, a portion of a video frame that is encoded at higher quality may preserve more information and may present a sharper image than a lower quality portion after decoding. This selective encoding allows the video to be streamed at an overall lower data rate while preserving quality of important portions of the video, which are referred to herein as “primary object regions.” In particular, the primary object regions may constitute a portion of a video frame that corresponds to a set of pixels that show one or more objects or regions of interest within a scene produced by the video frame when presented on a display. In some embodiments, selective encoding of portions of streamed video may be elected to simply reduce data rate for transmitting video content, even if bandwidth is available to stream all portions of a video frame at a data rate consistent with high image quality. In other embodiments, selective encoding during video streaming may be triggered based upon a determination that available bandwidth is insufficient.

Some examples of quality features that may be varied to vary image quality include the bit rate used for transmission of an image portion of a video frame; the size of a macroblock used in block motion compensation; the use or non-use of variable block motion compensation to encode different portions of an image frame; the use of lossless as opposed to lossy compression, and other features. The embodiments are not limited in this context. Thus, in one scenario a primary object region that is encoded at a relatively higher image quality may be encoded with more bits than a background region of comparable size that is encoded at a relatively lower image quality. In another scenario, a primary object region may be encoded with lossless compression while a background region is encoded with lossy compression. For example, the color space of a background region subject to lossy compression may be reduced to reflect only the most commonly used colors of a video image, while the color space of a primary object region is not reduced during compression.

Some embodiments involve using a face detection engine found in or utilized by graphics hardware to determine the area of interest in a video frame during low bandwidth scenarios. The area of interest, which constitutes a primary object region, is then encoded with higher quality and the rest of the video frame with lower quality. This may involve varying one or more of the aforementioned quality features according to whether the portion being encoded is to receive higher quality encoding or lower quality encoding.

Some advantages of the present embodiments, but necessary features of any embodiment, include an improved user experience such as in a video conferencing setting under network bound cases in which bandwidth may limit bit rate for streaming video content. Improved user experience may be provided by the present embodiments as well in cases that are not network bound, where a video streaming application may employ available bandwidth to encode objects or regions of interest faces in much higher quality than the rest of a video frame. Other embodiments involve object detection where any object or region in the video can be identified and encoded at higher or much higher resolution in comparison to other regions of a video frame.

By way of background, in current technology, video is streamed between a source and a destination or receiver with the aid of components including codecs that encode and decode digital data that carries the video content. Present day codecs are designed to encode video frames at a “global” level, where the encoding properties are pre-determined for all pixels in the image. Thus, when available bandwidth limits the data stream rate to a rate that is insufficient to stream a video frame at a given level of quality, the entire video frame is encoded at a lower level of quality to meet the limited bandwidth requirement.

The present embodiments may improve upon the above approach by providing selective encoding in which different portions of a video frame are prioritized so that encoding of the different portions generates a quality of portions given a higher priority that is higher than other portions. Thus, instead of a uniformly degraded video image, a user is presented with a video image that selectively preserves image quality of portions of the image that may have more information or are of more interest to the user as compared to other portions of less interest that are presented with lower quality.

As detailed in the figures to follow, the present embodiments may enhance video streaming experience in different use scenarios including real time one way video streaming, live video conferencing, two way live video communications, and streaming of pre-recorded content, to cite some examples.

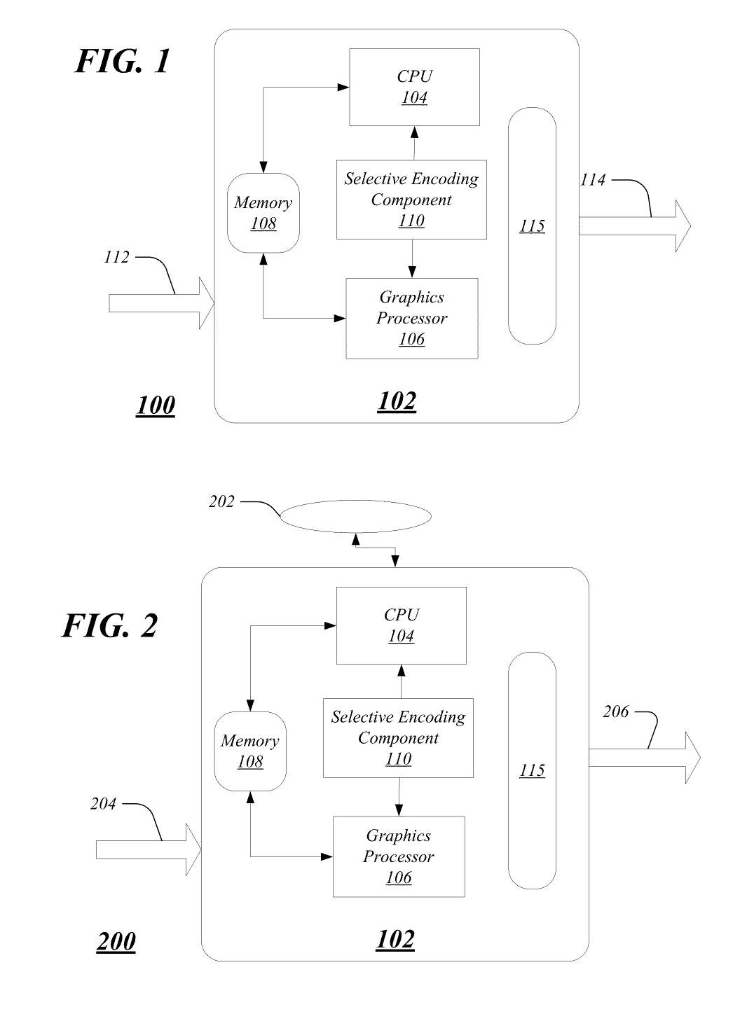

FIG. 1 depicts one arrangement 100 for streaming video according to various embodiments. An apparatus 102 acts as a source or sender of streaming video content. The apparatus 102 includes processor circuitry for general processing that is shown as a CPU 104, as well as a graphics processing circuitry shown as graphics processor 106 and memory 108. The apparatus 102 also includes a selective encoding component 110 whose operation is detailed below. The apparatus 102 may receive video content 112 from an external source or the video content may be stored locally in the apparatus 102 such as in the memory 108. The video content 112 may be processed by the selective encoding component 110 and output as selectively encoded video stream 114 for use by a receiving device (not shown). As detailed in the FIGs. to follow, a receiving device may be one or more client device(s) that is receiving prerecorded video content, may be a peer device that is engaged in a two way video session, may be a device or devices connected to a videoconference, or may be one or more devices receiving a live video stream provided by the apparatus 102. The embodiments are not limited in this context.

Consistent with the present embodiments, an apparatus such as apparatus 102 may be configured to stream video in two or more different modes. In one example, when bandwidth is sufficient, video may be streamed at a standard rate such that video frames present high quality image across the entire video frame, that is, in all pixels, where “high quality” represents a first quality level of images presented in the video frame. When a triggering event, such as a message or signal is received indicating low bandwidth, or other determination is made that bandwidth is low or limited, the apparatus 102 may begin streaming video by selectively encoding the video as detailed below. During the selective encoding the video may be streamed at an overall lower data rate (bit rate) as compared to the standard rate. In addition, portions of the selectively encoded video stream representing primary object regions may receive encoding at a better level that maintains the quality of pixels in a video frame associated with the object at a level higher than in other regions of the video frame. The latter regions are encoded to generate a lower quality in pixels that display these regions so that the data rate for generating these latter regions is lowered. It is to be noted that in the description to follow the term “primary object region” may be used to refer to a single contiguous region of a video frame or may refer to multiple separate regions of a video frame that are classified as primary object(s). Similarly a “background region” may be used to refer to a single contiguous region of a video frame or may refer to multiple separate regions of a video frame that are classified as being outside the primary object region.

FIG. 2 shows an arrangement 200 for operating the apparatus 102 consistent with various embodiments. In this arrangement 200, the apparatus 102 is configured to receive a signal 202 that indicates to the apparatus 102 to selectively encode video content to be streamed from the apparatus 102. The signal 202 may be a message or data that is triggered when a low bandwidth condition exists such that streaming video from the apparatus 102 at a standard bit rate in which video frames present a high quality image across the entire video frame is not to be done. In some embodiments, the selective encoding component 110 may be configured to perform selective encoding when bandwidth is below a bandwidth threshold. In response to the signal 202, video content 204 may be loaded for processing by the selective encoding component 110, which generates the selectively encoded video stream 206.

The selective encoding component 110 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

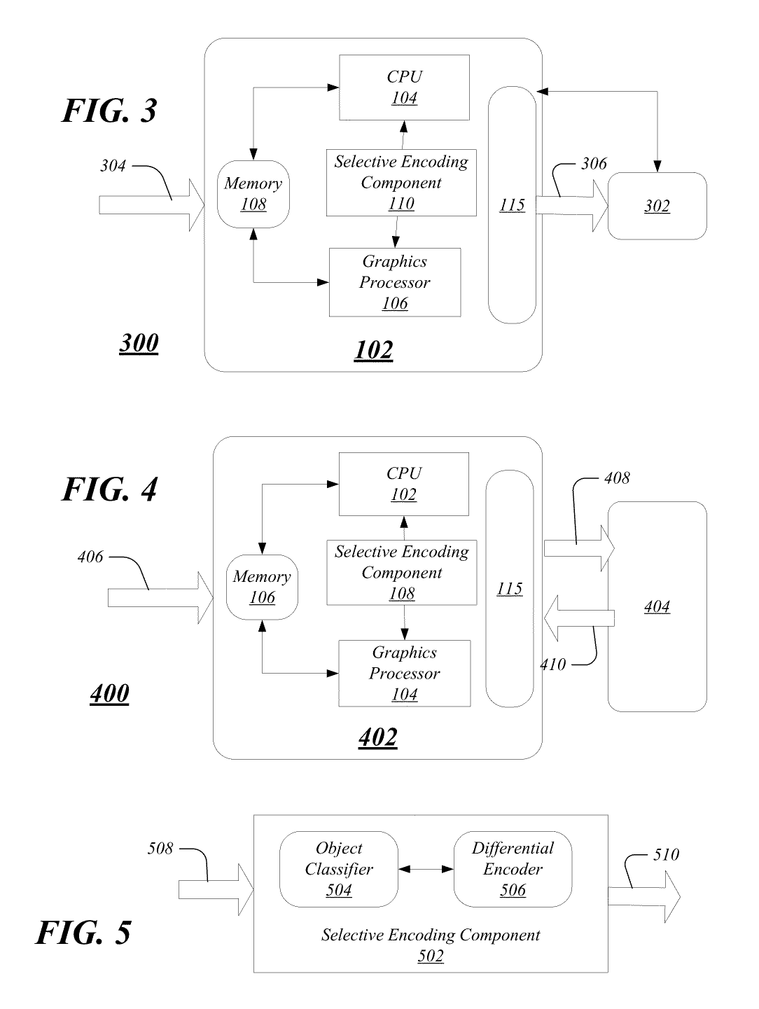

FIG. 3 shows an arrangement 300 for operating the apparatus 102 consistent with additional embodiments. In this arrangement 300, the apparatus 102 is configured to load prerecorded video content 304 for processing by the selective encoding component 110, which generates the encoded video stream 306. The encoded video stream 306 may be generated when a client or receiving device 302 communicates with the apparatus 102 to select the video content 304 for streaming. In some variants the apparatus 102 may dynamically alter encoding of the video content for the encoded video stream 306 such during streaming of the video content 304, certain portions of the encoded video stream 306 are non-selectively encoded while other portions of the encoded video stream 306 are selectively encoded. For example, the video content 304 may be a prerecorded movie. During certain periods of streaming the movie bandwidth conditions may be such that the encoded video stream 306 is streamed at a uniformly high quality across the entire video frame. During other periods, reduced bandwidth conditions may trigger the encoded video stream 306 to be streamed with reduced quality in background portions of each video frame while a higher quality is preserved in primary object regions within the video frame.

FIG. 4 shows another arrangement 400 for operating the apparatus 102 consistent with additional embodiments. In this arrangement 400, an apparatus 402 is configured to send encoded streaming video 408 to apparatus 404 and receive encoded streaming video 410 from apparatus 404. The encoded streaming video 408 may be generated from video content 406. In some instances transmission of encoded streaming video 408 may take place at the same time that encoded streaming video 410 is received. The encoded streaming video 408 may in particular be selectively encoded at least in portions depending upon bandwidth conditions. In some embodiments the encoded streaming video 410 may also be selectively encoded at least in portions depending upon bandwidth conditions.

In various embodiments, the selective encoding component may include a classifier component that is configured to identify or recognize portions of a video frame as to the content contained in those portions, and may classify different portions of a video frame based upon the identification. Thus, portions may be identified and/or classified as to whether those portions present background or foreground of an image, or other region of interest. Portions that depict human faces may be identified, portions that depict human figures may be identified, and so forth. The selective encoding component may also include an encoder engine that differentially encodes different portions of a video frame based upon input from the classifier component.

FIG. 5 depicts one embodiment of a selective encoding component 502, which includes an object classifier 504 and differential encoder 506. As illustrated, a video frame 508 is loaded to the object classifier 504, which may employ one or more different procedures to identify and classify portions of the video frame 508. For example, the video frame may contain a human positioned in an outdoors setting. The object classifier 504 may identify one or more regions of the video frame 508 as depicting objects of interest such as foreground of an image or a face. The object classifier 504 may classify other portions of the video frame 508 as background. This information may be forwarded to the differential encoder 506, which may treat, for example, data associated with a face depicted in the video frame 508 differently than data associated with background in the video frame 508. For example, during preparation for transmitting the video frame, the data associated with the face portion may undergo less compression than that applied to background portions. In other words, a first ratio defined by a ratio of the bits to represent the compressed face portion to the bits used to originally present the uncompressed face portion may be higher than a second ratio defined by the ratio of bits to present compressed background portions to bits used to represent the uncompressed background portions.

The output of the selective encoding component 502 is a selectively encoded video frame 510, which may include two or more encoded image portions, where at least two of the different encoded image portions are encoded differently. The selectively encoded video frame 510 may also include the positional information that identifies where in the video frame that is being transmitted each encode image belongs. It is to be noted that the two or more encoded image portions of an encoded video frame such as selectively encoded video frame 510 need not be transmitted together or in a particular order so long as information is transmitted that identifies the video frame to which the encoded image portion belongs and its location within that video frame. In some instances the image portions may be encoded and transmitted as separate sub-frames.

In some embodiments foreground regions of a video frame may be classified by the object classifier 504 as primary object regions that are separated from background regions. This classification may be performed automatically by employing conventional techniques that exploit temporal similarity within an image. In other embodiments overlay graphics of video frames may be classified as primary object regions. For example, conventional applications that add overlay graphics to a video, such as a streaming sports video, may be used by a selective encoding component to extract the regions of a video frame that include the overlay graphics. In some instances the overlay graphics application may generate this information directly or a conventional “frame difference” method may be employed to detect the overlay graphics portions of the video frame since the overlay graphics portions are relatively static within a succession of video frames.

In further embodiments, the object classifier 504 may employ other conventional tracking approaches such as applications or used to isolate individuals within a video that transmits a sports event. For example, the isolated individuals may be assigned as primary object regions to be encoded at a higher quality.

In still other embodiments, the classification as to what portion of a video frame constitutes a primary object region may be based upon user interaction with the video being streamed. In particular, the object classifier 504 may receive signals indicating user activity, such as real time user activity of a user employing a device that receives video from the selective encoding component 502. For example, regions of a video frame that lie in the periphery of a user's field of view may be classified as background regions. In particular embodiments, user eye movement may be tracked and this information fed back to the object classifier to determine the real time user peripheral regions that are then encoded by the differential encoder 506 at a lower quality.

In still further embodiments, the object classifier 504 may receive a signal from a receiving device indicating that the user is no longer watching a video being streamed by a device that contains the selective encoding component 502. For example, if the user is detected as walking away from a device that is receiving the streamed video, or the user has selected a different application on the device, the object classifier 504 may stop streaming altogether video frames of a “video” media that includes video and audio content. Instead, only the audio portion of the “video” may be streamed to the receiving device.

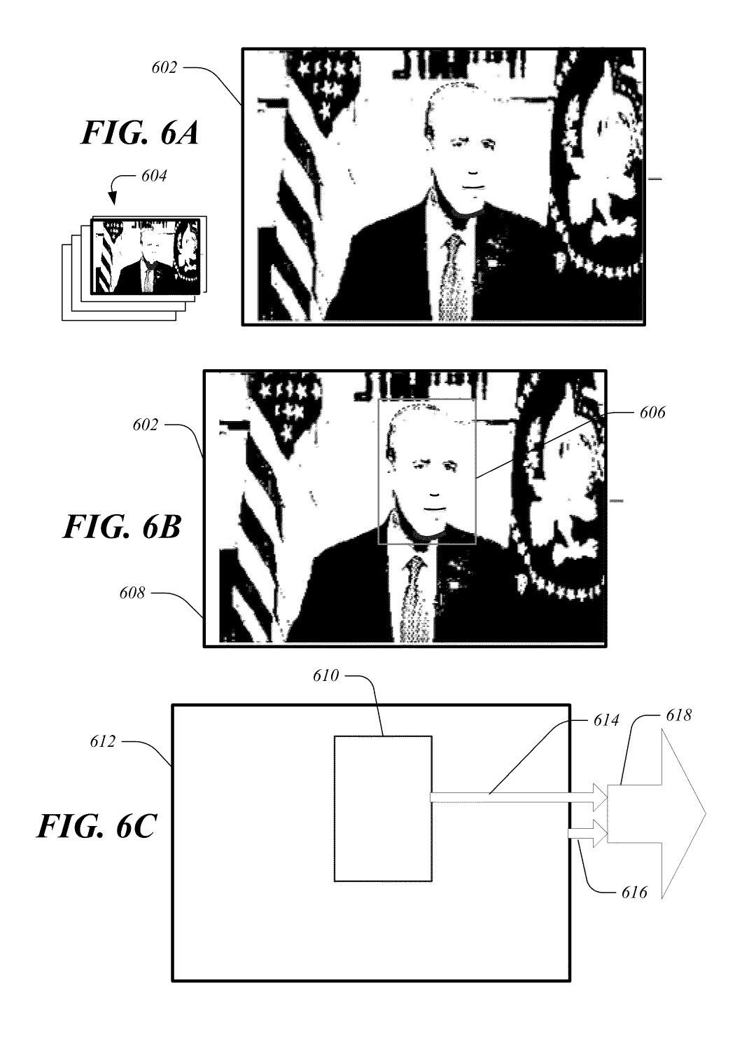

FIG. 6A to FIG. 6C depict one example of differential encoding of video for streaming consistent with the present embodiments. A single video frame 602 is shown in FIG. 6A. The video frame 602 is illustrated as it may be presented upon a suitable display. In one scenario, the video frame 602 may be part of video content that is streamed during live streaming of an event, such as in a videoconference between two or more locations, or alternatively the video content may form part of a live video that is streamed via the Internet. Thus, the video frame 602 and a succession of video frames that depict similar visual content to that shown in FIG. 6A may be streamed from a sending device such as the apparatus 102 to one or more receiving devices. In such context, under certain circumstances, such as low bandwidth conditions, it may become necessary to stream the video 604 of which video frame 602 forms a part, at a data rate that is insufficient to transmit each video frame in its entirety at a high quality level. Accordingly, the video frame 602 may be processed by a selective encoding component to encode the video frame in a manner than may preserve a higher quality for specific portions of the video frame 602.

As depicted in FIG. 6B, the content of the video frame 602 may be analyzed by an object classifier that is configured to perform face recognition in order to identify faces within an image. In various embodiments face detection may be implemented in an Intel® (Intel is a trademark of Intel corporation) graphics processor that includes multiple graphics execution units, such as 16 or 20 execution units, to implement face detection. The embodiments are not limited in this context. In scenarios such as videoconferening, faces may be prioritized for higher quality encoding since a participant's face may be deemed to constitute an important part of the image to be transmitted. In one example, a face detection engine may constitute firmware embedded in a graphics component such as a graphics accelerator. The face detection engine may be employed to isolate one or more regions of a video frame that are deemed to depict faces.

In FIG. 6B a single face region 606 is identified which corresponds to a portion of the video frame that contains a face or at least a portion of a face. Region 608 of the video frame 602, which lies outside face region 606, may be deemed to be a non-face region or background region.

Turning now to FIG. 6C, the coordinates of each region within the video frame 602 may be identified so that the content of each region may be encoded differently. For example, the content 610 of the face region 606 may be output as encoded video portion 614, while the content 612 of the region 608 is output as encoded video portion 616. The encoded video portion 614 may be encoded to generate a higher quality image than the encoded video portion 616. The encoded video frame content 618 that is thus generated from video frame 602 may thus include encoded video portions 614, 616, as well as other information such as information that identifies the position (coordinates) of each encoded video portion 614, 616 within a video frame to be constructed by a receiving device.

In various embodiments, the selective encoding to generate the encoded video frame content may be implemented by an Intel® graphics processor that includes a video motion estimation engine in conjunction with an encoder to optimize the selective encoding. A video motion estimation engine may facilitate more rapid encoding and therefore is useful for regions where encoding is to be performed at a higher quality, which may require more computation resources. In particular, when the encoder is apprised of the face region 606, the encoder may harness the video motion estimation engine to focus on the face region 606 and not on the region 608. Because the video motion estimation engine may consume relatively higher power during encoding, the selective encoding process may also result in a more energy-efficient encoding process. This is due to the fact that the video motion estimation is focused on regions to be encoded at higher quality levels, which may only occupy a small portion of a video frame as in the example of FIGS. 6A-6C. Accordingly, a majority of a video frame may require much less treatment by the video estimation engine.

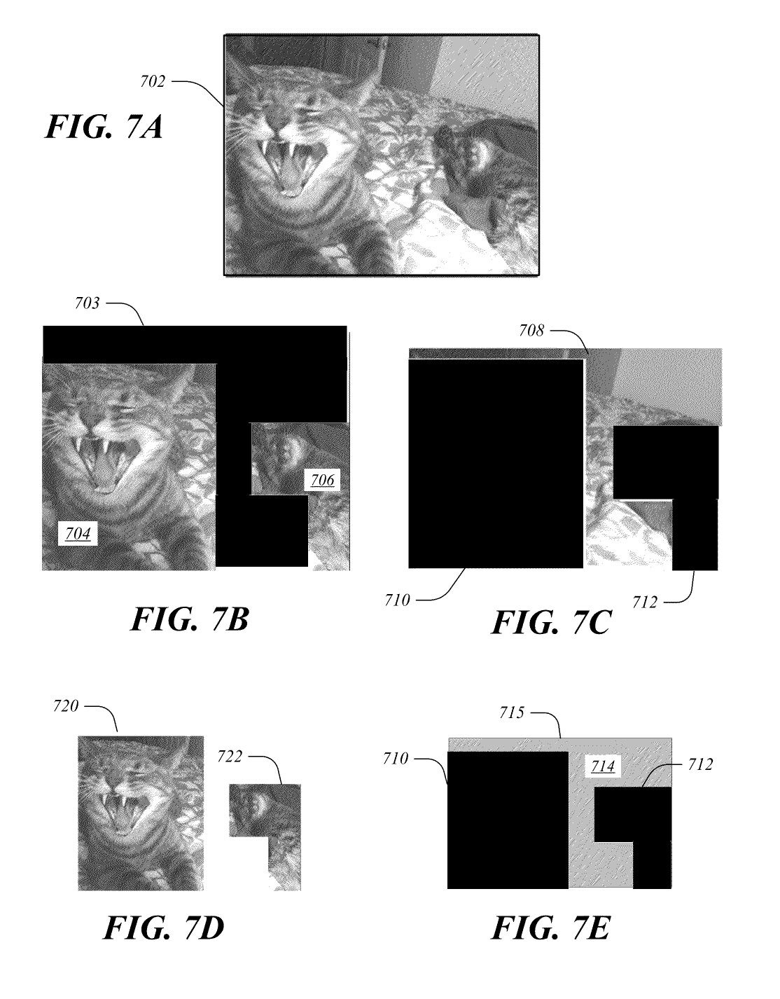

FIGS. 7A-7E illustrate one example of generating a selectively encoded video stream according to further embodiments. In FIG. 7A, there is shown a representation of a video frame 702 before selective encoding. The video frame 702 includes depiction of a first cat and second cat as well as background portions. During conventional processing the video frame 702 may be processed such that all portions of the video frame are encoded in a similar fashion. When selective encoding is performed on the video frame 702 by a selective encoding component, pixels or regions of the video frame 702 are classified according to their importance or level of information content that is contributed to the image depicted in FIG. 7A. As illustrated in FIG. 7B, for example, regions 704 and 706 are identified as foreground or primary object regions, which depict a first cat and second cat, respectively. In this example, the regions 704 and 706 are separated from one another such that none of their respective pixels adjoin pixels of the other region. Accordingly, each region 704, 706 may be encoded separately. This encoding may be performed by employing any suitable codec for the application used to stream the video frame 702. Since the regions 704, 706 are determined to be primary object regions, their encoding is performed in a manner to preserve higher quality of the regions 704, 706 when decoded after transmission.

In addition, the selective encoding component may generate positional information that identifies to a decoder the position for each region 704, 706 to be placed within a decoded video frame that presents the image of the video frame 702. In one implementation, the positional information may include the coordinates of an upper left pixel for each region 704, 706.

In various embodiments, a selective encoding component may generate multiple encoded subframes for sending to a receiving device in which a first subframe includes the primary object regions and a second subframe includes background regions. FIG. 7B depicts one illustration of a subframe 703 that includes the regions 704 and 706. The portions of the subframe 703 that lie outside the regions 704, 706 may be encoded in any pattern that is deemed to be efficient for the selected compression algorithm. In some implementations the encoding might be a solid color. For example, if an image contains large portions of red, solid red may be chosen for the encoding. The illustration in FIG. 7B of a solid black encoding is for purposes of illustration only.

Turning to FIG. 7C, there is illustrated the identification of the background region 708, which borders the regions 704, 706. As illustrated, the background region 708 constitutes portions of the video frame 702 with blanked regions 710, 712 corresponding to the respective regions 704, 706 and containing no information. The background region 708 may be sent for encoding in a manner that compresses the background region 708 so that less data per pixel is required to transmit the background image as compared to the encoding of the regions 704, 706. This may result in a lower image quality of background region 708 when transmitted and decoded.

Turning to FIG. 7D, there are shown representative selectively encoded regions 720, 722 corresponding to the regions 704, 706 after encoding to preserve a higher image quality as noted.

In FIG. 7E there is shown a subframe 715 that includes a bitmask 714, which may be generated and transmitted to a decoder in addition to the selectively encoded portions of the video noted above. The bitmask 714 may serve as a reference to indicate which pixels of a data frame belong to background of the data frame. The selective encoding component may subsequently compress and send the subframe 715 including the respective selectively encoded regions 720, 722, bitmask 714 for reception. In addition selectively encoded background region (not shown) may be sent for reception by a receiving device that is in communication with a sending device that performs the selective encoding.

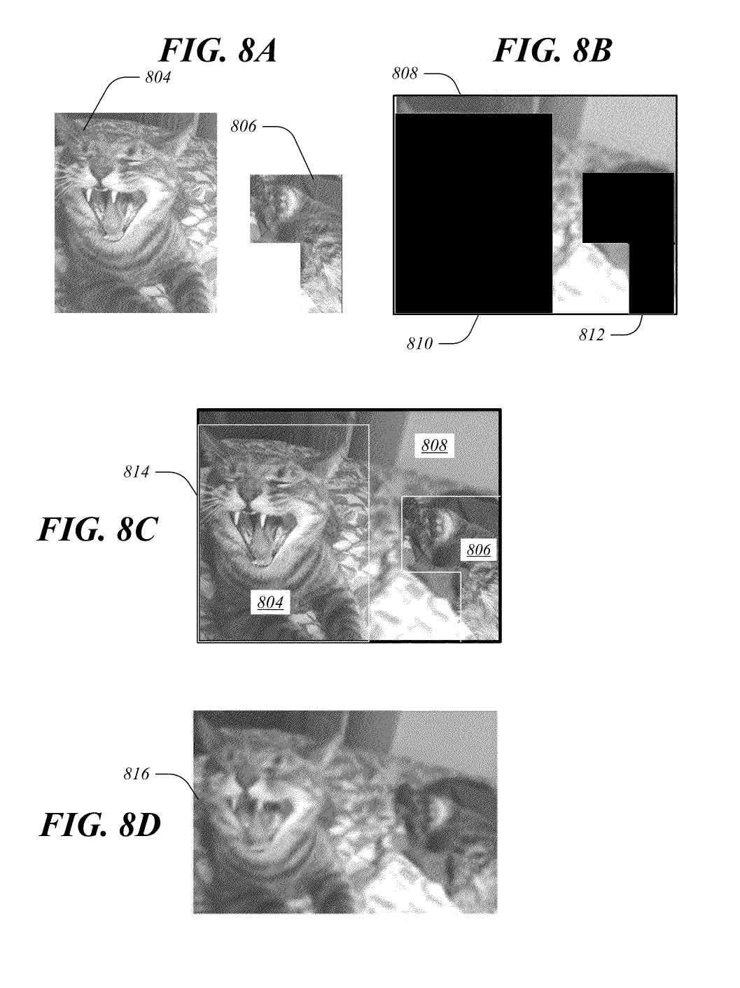

FIGS. 8A-8D depicts a scenario of decoding of selectively encoded video content consistent with various embodiments. Continuing with the example of FIGS. 7A-7E, the video content associated with the video frame 702 may be received as follows. The selectively encoded regions 720, 722 may be received by a decoder of a receiving device. FIG. 8A depicts a decoded region 804 corresponding to the selectively encoded region 720 and a decoded region 806 corresponding to the selectively encoded region 722. Because the selectively encoded regions 720, 722 were encoded in a fashion to preserve higher image quality, the decoded regions 804, 806 may represent the regions 704, 706 of the video frame 702 more closely than decoded background regions reproduce original background region 708. As shown in FIG. 8B, the decoded background region 808 (shown with the blanked regions 810, 812) may have a lower quality than the original background region 708. Using positional information for the selectively encoded regions 720, 722 that were supplied together with the selectively encoded region 720, 722, the decoder may reconstruct a decoded video frame 814 as shown in FIG. 8C. The decoded video frame 814 includes a lower quality background region, decoded background region 808 together with higher quality regions representing foreground or animals, that is, the decoded regions 804, 806. This allows a viewer to appreciate the decoded video frame 814 that includes higher quality regions corresponding to objects that may be of more interest to the viewer than other regions.

In contrast, FIG. 8D illustrates an example of a non-selectively encoded and decoded video frame, that is, video frame 816, which is based upon the video frame 702. As illustrated, the quality of the image is uniformly degraded across the whole video frame.

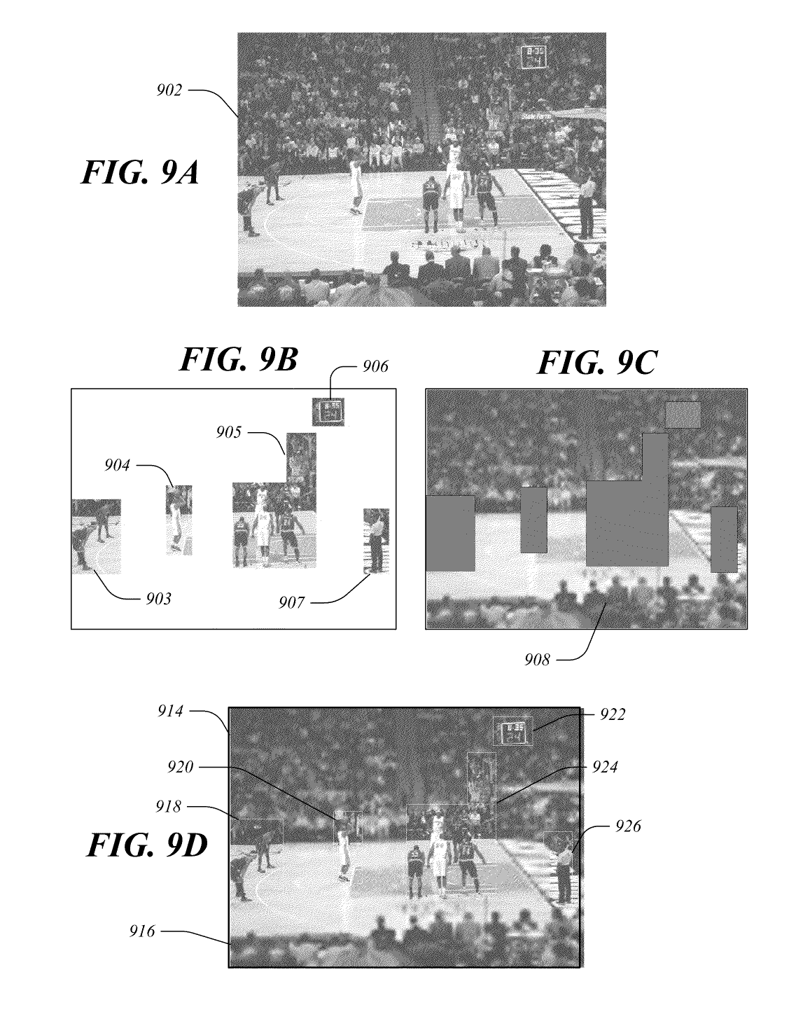

Although the above FIGs. that depict selective encoding illustrate examples in which foreground or primary regions have the shape of regular blocks, in various embodiments such foreground or primary regions may have more complex shapes. An example of this is illustrated in FIGS. 9A-9D. In FIG. 9A there is shown a video frame 902 that depicts an instance during a sports event. In FIG. 9B an object classifier has identified foreground regions 903, 904, 905, 906, 907 that each include human figures and may be deemed primary object regions. In FIG. 9C background regions 908, 910, 912 are illustrated, which are separated from one another by the foreground region 906. Notably, the foreground regions 904, 906 and background region has a complex shape although it may be constructed from the assembly of multiple regularly shaped blocks of pixels.

Each of the foreground regions 903, 904, 905, 906, 907 and background region 908 are illustrated after selective encoding in which the foreground regions 903-907 are encoded to preserve a higher image quality as opposed to the background region 908.

In FIG. 9D, an example of a decoded video frame 914 is shown which is based upon the selective encoding of the video frame 902. As illustrated, the decoded video frame 914 exhibits a background region 916 that is more blurry than the original background of the video image shown in video frame 902. This facilitates the preservation of higher quality foreground regions 918, 920, 922, 924, and 926 under conditions in which it may be desirable or necessary to transmit the video frame 902 at a lower data rate than that which is sufficient to preserve image quality throughout the video frame 902 after reception.

In further embodiments the selective encoding of video for streaming may be performed in a manner that dynamically adjusts objects or portions of a video frame that are classified as primary object regions. Thus, regions of a video frame or succession of video frames that initially are classified as primary object regions for selective encoding at a relatively higher quality may be changed to background where encoding is at a relatively lower quality. In addition, other regions of the succession of video frames that initially are deemed as background regions for selective encoding at a relatively lower quality may be changed to primary object regions where encoding is performed at a relatively higher quality.

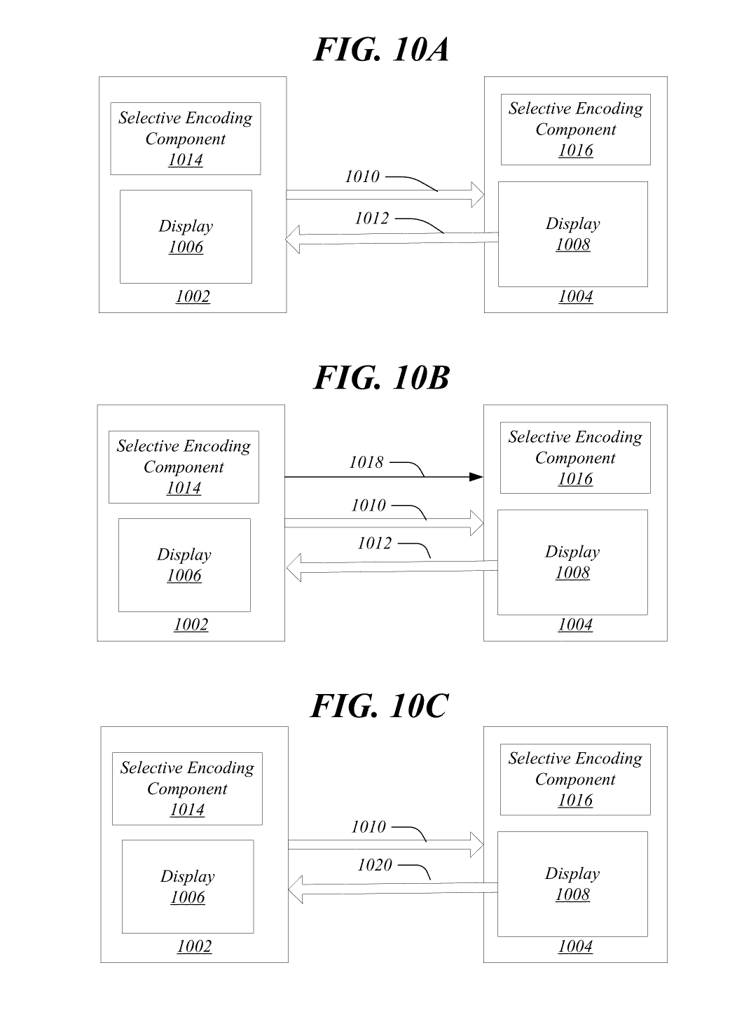

In some embodiments, the switching of classification of objects from primary to background, or vice versa, may be generated responsive to user input. FIGS. 10A to 10C depict one scenario for dynamic selective encoding of video streaming. In this example, two different devices 1002, 1004 are in communication with one another via video streaming. The device 1002 includes a selective encoding component 1014 to stream selectively encoded video to the device 1004 and a display 1006 to present streaming video received from the device 1004. Similarly, the device 1004 includes a selective encoding component 1016 to stream selectively encoded video to the device 1002 and a display 1008 to present streaming video received from the device 1002. In the instance of FIG. 10A, the device 1002 streams video 1010 to the device 1004. The video 1010 may be video recorded in real time by a user of the device 1002, which depicts the user of device 1002 and user environs. Similarly, the device 1004 streams video 1012 to the device 1002, which may depict a user of the device 1004 and user environs. In both cases the video 1010, 1012 may be selectively encoded or may be non-selectively encoded in which all of a video frame is encoded in the same manner.

In some embodiments, the selective encoding for streaming video from device 1004 may be adjusted responsive to signals from the device 1002. For example, a user of the device 1002 may receive video 1012 that depicts the user of the device 1004. The user of device 1002 may employ a touchscreen interface on the display 1006 to select pixels of video frames that the user wishes to be rendered in higher quality.

Alternatively, the user of device 1002 may employ another selection device such as a mouse, touchpad, tracking of user's eyes to detect region of interest over a period of time, or other user interface to interact with the display 1006 in order to select the pixels of a video frame. FIG. 10B depicts a scenario in which a signal 1018 is sent to the device 1004. The signal 1018 may indicate the user selected region of pixels of a video frame of the video 1012 that the user of device 1002 wishes to receive at higher quality. An example of this is peer to peer video streaming in which the video 1010 contains the face of user of device 1002 and the video 1012 contains the face of the user of device 1004, each of which may be initially deemed as foreground objects for selective encoding at higher image quality. However, at some point the user of device 1002 may select another object within the video 1012 being received for emphasis. For example, the user of device 1004 may wish to show an object in the user's (of device 1004) hand to the user of device 1002. Initially, in the scenario of FIG. 10A, the region of the video 1012 that captures the hand of the user of device 1004 maybe blurry due to selective encoding at a lower data rate. Accordingly, the user of device 1004 may signal to the user of device 1002 by voice or motion the desire to show what is in the hand of user of device 1004. This may cause the user of device 1002 to touch the display 1006 in a region corresponding to the hand of the user of device 1004. The position of the selected object with a video frame of the video 1012 may then be forwarded to the selective encoding component 110. Subsequently, the selective encoding component 1006 performs the appropriate adjustment to classification of video frames being transmitted to device 1002, so as to encode regions depicting the hand of the user of device 1004 at a higher quality.

In some cases, depending, for example on bandwidth for transmission of video between device 1002 and device 1004, or other considerations, the selective encoding component 1016 may adjust regions of video frames of video 1012 to reduce the quality of encoding in order to accommodate increased quality of encoding in another region. For example, the face of the user of the device 1004 may be encoded such that the face appears blurry upon decoding by device 1002 in order to transmit an image of the user's hand more clearly.

The adjusted video whose encoding is different from that of video 1012 is shown as video 1020. In various embodiments, the video 1020 may be subject to further adjustment so that the primary object regions of video that are encoded with relatively higher quality than other regions are once again changed. In this manner, the user of device 1002 may experience a video in which the regions of a video frame that are presented with higher quality are dynamically shifted one or more times during streaming of the video. As noted, the user of device 1002 may guide the selective encoding of the video being received from device 1004.

Although the aforementioned embodiments may depict primary object regions as distinct from background region when presented on a display, in various embodiments smoothing procedures or algorithms may be employed to transition between primary object regions and background regions so that the resolution of features in an image varies gradually. These smoothing procedures may include procedures to account for a succession of video frames such that differently encoded regions blend together nicely as a video is playing.

In further embodiments, video encoding may be performed to encode different regions of a video frame at three or more different encoding levels. For example, a human face that is presented in a video frame may be encoded at a first quality level while a human figure outside the face may also be classified as a secondary object region and may be encoded at a second quality level less than the first quality level. Other portions of the video frame may be presented at a third quality level less than the second quality level.

In addition to encoding different portions of a video frame with different quality, in other embodiments, portions of a video frame classified as primary object regions may be assigned a higher priority for transmission to a receiving device. This prioritization of selected portions of a video frame for transmission according to the quality of encoding provides an additional advantage of preserving video quality under circumstances in which video is imperfectly streamed to a receiving device. For example, during transmission of an encoded video frame if data packets containing the selectively encoded primary object regions are transmitted before data packets containing background regions, the primary object regions may also be decoded first by a decoder of a receiving device. If, under certain transmission conditions, the decoder needs to display a subsequent video frame before data packets containing all pixels of the encoded video frame have reached the receiving device, there is a greater chance that data packets containing pixels of the primary object regions have reached the decoder and can be displayed so that the user may perceive the primary object regions of the video frame before a subsequent video frame is presented even if the background of the video frame is not received.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

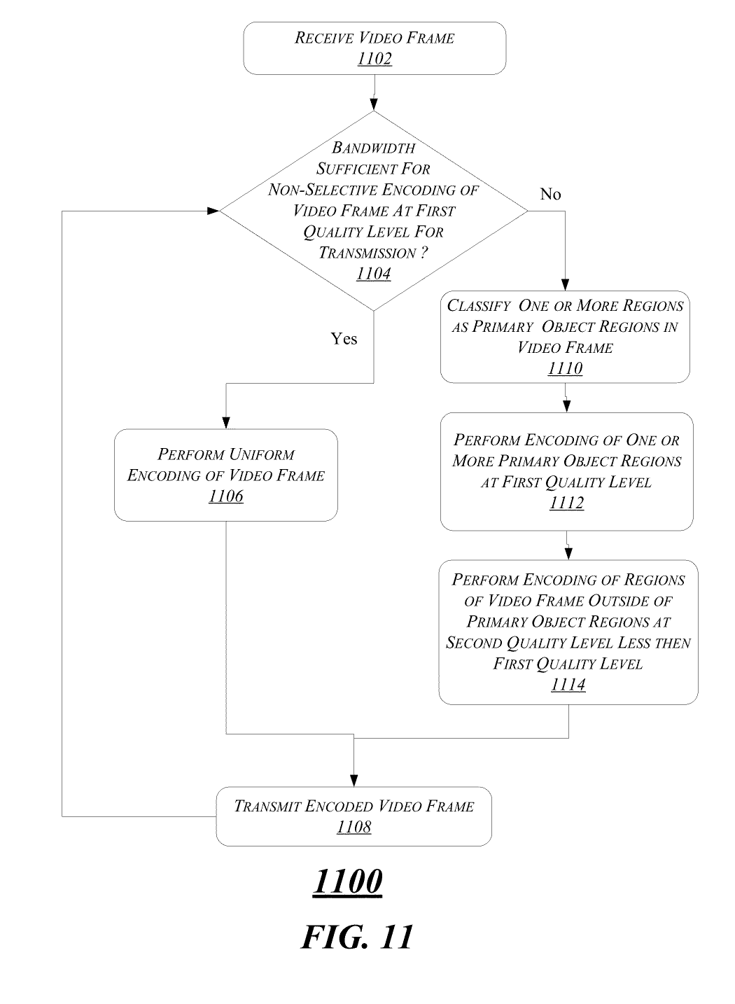

FIG. 11 illustrates an exemplary first logic flow 1100. At block 1102, a video frame is received. In some implementations the video frame may be received in a device to generate real time video streaming. In other cases the video frame may be part of prerecorded and prestored video content received by a device for streaming to another device.

At block 1104 a determination is made as to whether bandwidth is sufficient for non-selective encoding of the video frame at a first quality level for transmission. The non-selective encoding may encode the entire video frame at a first quality level corresponding to a first bit rate. If so, the flow moves to block 1106 where the video frame in uniformly encoded at the first quality level. The flow subsequently moves to block 1108 where the encoded video frame is transmitted.

If, at block 1104 it is determined that bandwidth is not sufficient for selective encoding, the flow moves to block 1110. At the block 1110, one or more regions are classified as primary object regions within the video frame. The primary object regions may constitute a portion of the video frame that when presented upon a display, corresponds to a set of pixels that show one or more objects or regions within a scene depicted by the video frame. The flow then moves to block 1112.

At block 1112 encoding of the one or more primary object regions is performed at the first quality level. In alternative embodiments, the one or more primary object regions are encoded at a different quality level that is different from the first quality level used for non-selective encoding. The different quality level may be higher than the first quality level or may be lower than the first quality level.

At block 1114, encoding of regions of the video frame outside the primary object regions is performed at a second quality level that is lower than the first quality level. The flow then proceeds to block 1108.

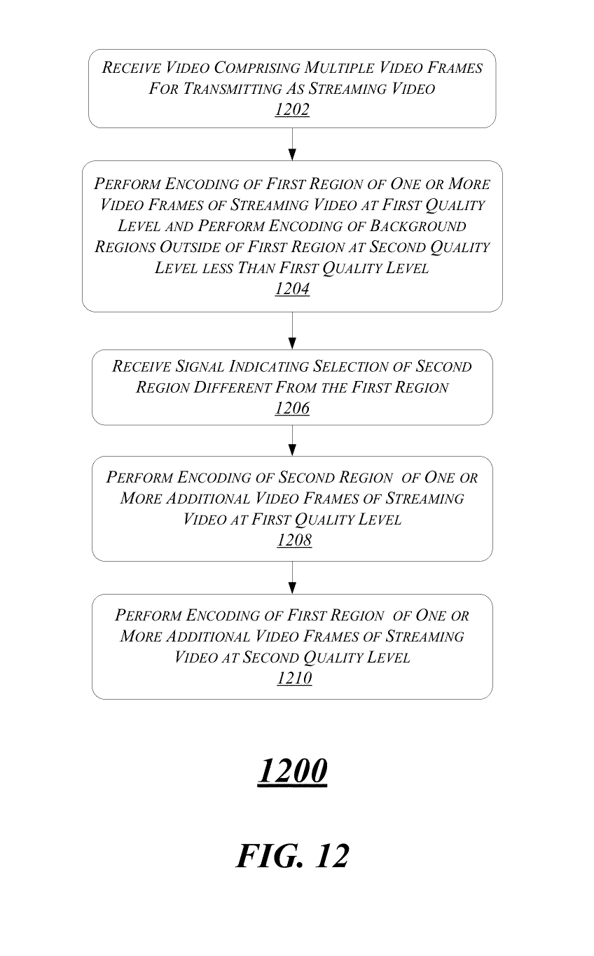

FIG. 12 illustrates an exemplary second logic flow 1200. At block 1202 video comprising multiple video frames is received for transmitting as streaming video. The video may be video that is recorded in real time for streaming or may be prestored video content. At block 1204, encoding of a first region of one or more video frames of the video is performed at a first quality level and encoding of background regions of one or more video frames of the video is performed at a second quality level less than the first quality level. The first region may constitute a portion of the video frame that when presented upon a display corresponds to a set of pixels that show one or more objects or regions within a scene depicted by the video frame. The background region may constitute a portion of the video frame that corresponds to pixels that show all other portions of a scene presented by the video frame except the first region.

At block 1206, a signal is received indicating selection of a second region of a video frame that is different from the first region. The signal may be received through a user interface such as a mouse, touchpad, joystick, touchscreen, gesture or eye recognition, or other selection device.

The flow then proceeds to block 1208 where encoding of the second region is performed at the first quality level for one or more additional video frames after the selection of second region. Subsequently the flow proceeds to block 1210 where encoding of the first region is performed at the second quality level for the one or more additional video frames.

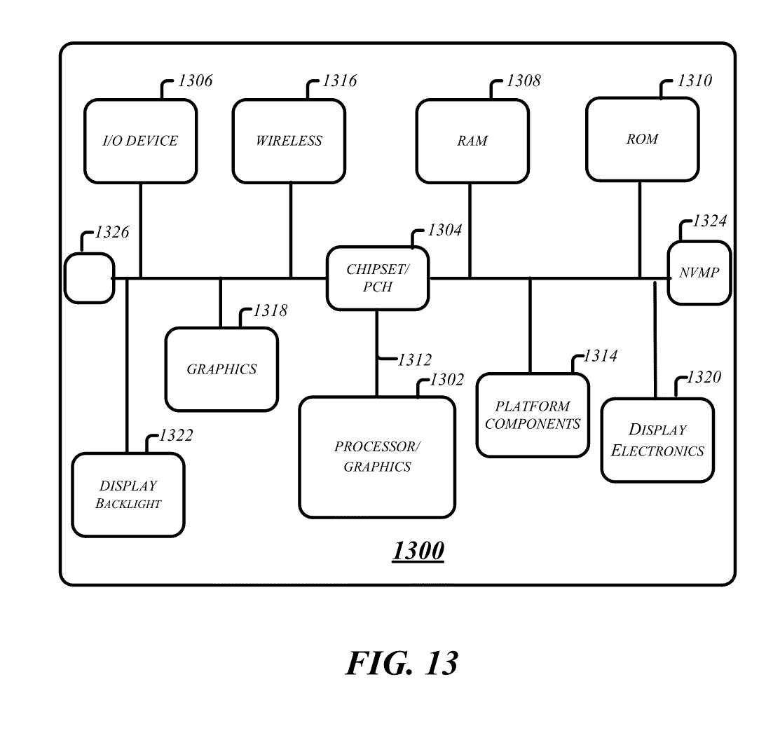

FIG. 13 is a diagram of an exemplary system embodiment and in particular, FIG. 13 is a diagram showing a system 1300, which may include various elements. For instance, FIG. 13 shows that system (platform) 1300 may include a processor/graphics core, termed herein processor 1302, a chipset/platform control hub (PCH), termed herein chipset 1304, an input/output (I/O) device 1306, a random access memory (RAM) (such as dynamic RAM (DRAM)) 1308, and a read only memory (ROM) 1310, display electronics 1320, display backlight 1322, and various other platform components 1314 (e.g., a fan, a crossflow blower, a heat sink, DTM system, cooling system, housing, vents, and so forth). System 1300 may also include wireless communications chip 1316 and graphics device 1318, non-volatile memory port (NVMP) 1324, and antenna 1326. The embodiments, however, are not limited to these elements.

As shown in FIG. 13, I/O device 1306, RAM 1308, and ROM 1310 are coupled to processor 1302 by way of chipset 1304. Chipset 1304 may be coupled to processor 1302 by a bus 1312. Accordingly, bus 1312 may include multiple lines.

Processor 1302 may be a central processing unit comprising one or more processor cores and may include any number of processors having any number of processor cores. The processor 1302 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 1302 may be multiple separate processors located on separate integrated circuit chips. In some embodiments processor 1302 may be a processor having integrated graphics, while in other embodiments processor 1302 may be a graphics core or cores.

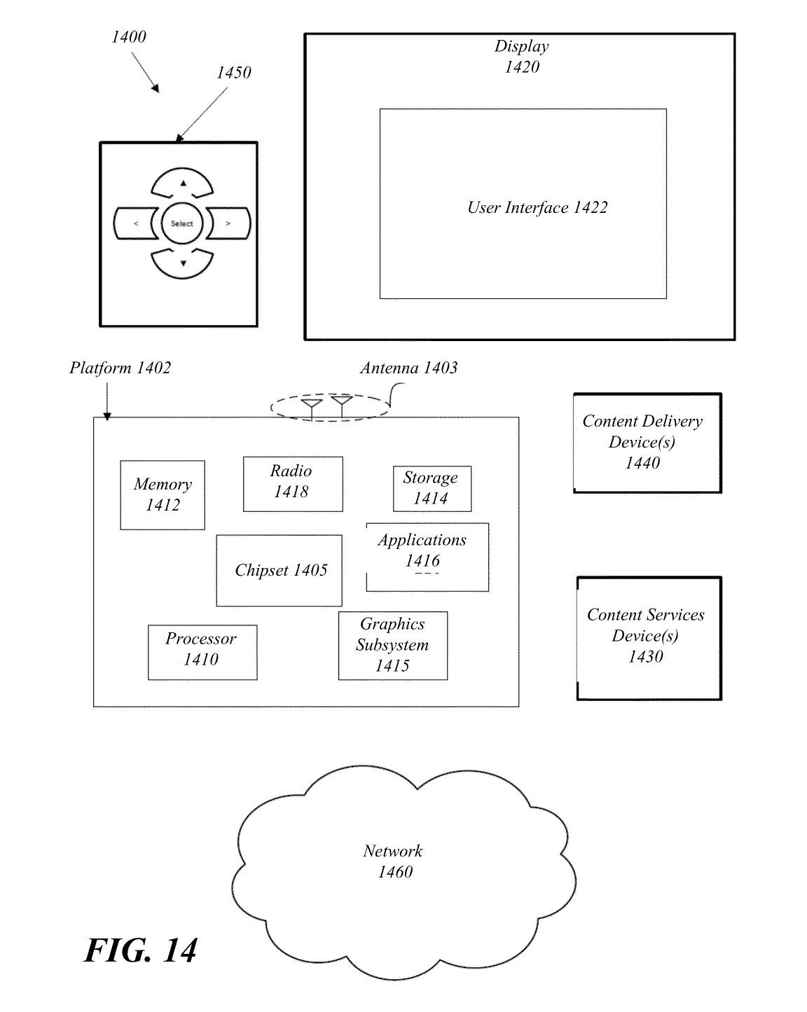

FIG. 14 illustrates an example system 1400 in accordance with the present disclosure. In various implementations, system 1400 may be a media system although system 1400 is not limited to this context. For example, system 1400 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1400 includes a platform 1402 coupled to a display 1420. Platform 1402 may receive content from a content device such as content services device(s) 1430 or content delivery device(s) 1440 or other similar content sources. A navigation controller 1450 including one or more navigation features may be used to interact with, for example, platform 1402 and/or display 1420. Each of these components is described in greater detail below.

In various implementations, platform 1402 may include any combination of a chipset 1405, processor 1410, memory 1412, antenna 1403, storage 1414, graphics subsystem 1415, applications 1416 and/or radio 1418. Chipset 1405 may provide intercommunication among processor 1410, memory 1412, storage 1414, graphics subsystem 1415, applications 1416 and/or radio 1418. For example, chipset 1405 may include a storage adapter (not depicted) capable of providing intercommunication with storage 1414.

Processor 1410 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1410 may be dual-core processor(s), dual-core mobile processor(s), and so forth.

Memory 1412 may be implemented as a volatile memory device such as, but not limited to, a Random Access Memory (RAM), Dynamic Random Access Memory (DRAM), or Static RAM (SRAM).

Storage 1414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1414 may include technology to increase the storage performance enhanced protection for valuable digital media when multiple hard drives are included, for example.

Graphics subsystem 1415 may perform processing of images such as still or video for display. Graphics subsystem 1415 may be a graphics processing unit (GPU) or a visual processing unit (VPU), for example. An analog or digital interface may be used to communicatively couple graphics subsystem 1415 and display 1420. For example, the interface may be any of a High-Definition Multimedia Interface, DisplayPort, wireless HDMI, and/or wireless HD compliant techniques. Graphics subsystem 1415 may be integrated into processor 1410 or chipset 1405. In some implementations, graphics subsystem 1415 may be a stand-alone device communicatively coupled to chipset 1405.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 1418 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1418 may operate in accordance with one or more applicable standards in any version.

In various implementations, display 1420 may include any television type monitor or display. Display 1420 may include, for example, a computer display screen, touch screen display, video monitor, television-like device, and/or a television. Display 1420 may be digital and/or analog. In various implementations, display 1420 may be a holographic display. Also, display 1420 may be a transparent surface that may receive a visual projection. Such projections may convey various forms of information, images, and/or objects. For example, such projections may be a visual overlay for a mobile augmented reality (MAR) application. Under the control of one or more software applications 1416, platform 1402 may display user interface 1422 on display 1420.

In various implementations, content services device(s) 1430 may be hosted by any national, international and/or independent service and thus accessible to platform 1402 via the Internet, for example. Content services device(s) 1430 may be coupled to platform 1402 and/or to display 1420. Platform 1402 and/or content services device(s) 1430 may be coupled to a network 1460 to communicate (e.g., send and/or receive) media information to and from network 1460. Content delivery device(s) 1440 also may be coupled to platform 1402 and/or to display 1420.

In various implementations, content services device(s) 1430 may include a cable television box, personal computer, network, telephone, Internet enabled devices or appliance capable of delivering digital information and/or content, and any other similar device capable of unidirectionally or bidirectionally communicating content between content providers and platform 1402 and/display 1420, via network 1460 or directly. It will be appreciated that the content may be communicated unidirectionally and/or bidirectionally to and from any one of the components in system 1400 and a content provider via network 1460. Examples of content may include any media information including, for example, video, music, medical and gaming information, and so forth.

Content services device(s) 1430 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1402 may receive control signals from navigation controller 1450 having one or more navigation features. The navigation features of navigation controller 1450 may be used to interact with user interface 1422, for example. In various embodiments, navigation controller 1450 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1450 may be replicated on a display (e.g., display 1420) by movements of a pointer, cursor, focus ring, or other visual indicators displayed on the display. For example, under the control of software applications 1416, the navigation features located on navigation controller 1450 may be mapped to virtual navigation features displayed on user interface 1422, for example. In various embodiments, navigation controller 1450 may not be a separate component but may be integrated into platform 1402 and/or display 1420. The present disclosure, however, is not limited to the elements or in the context shown or described herein.

In various implementations, drivers (not shown) may include technology to enable users to instantly turn on and off platform 1402 like a television with the touch of a button after initial boot-up, when enabled, for example. Program logic may allow platform 1402 to stream content to media adaptors or other content services device(s) 1430 or content delivery device(s) 1440 even when the platform is turned “off.” In addition, chipset 1405 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1400 may be integrated. For example, platform 1402 and content services device(s) 1430 may be integrated, or platform 1402 and content delivery device(s) 1440 may be integrated, or platform 1402, content services device(s) 1430, and content delivery device(s) 1440 may be integrated, for example. In various embodiments, platform 1402 and display 1420 may be an integrated unit. Display 1420 and content service device(s) 1430 may be integrated, or display 1420 and content delivery device(s) 1440 may be integrated, for example. These examples are not meant to limit the present disclosure.

In various embodiments, system 1400 may be implemented as a wireless system, a wired system, or a combination of both. When implemented as a wireless system, system 1400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 14.

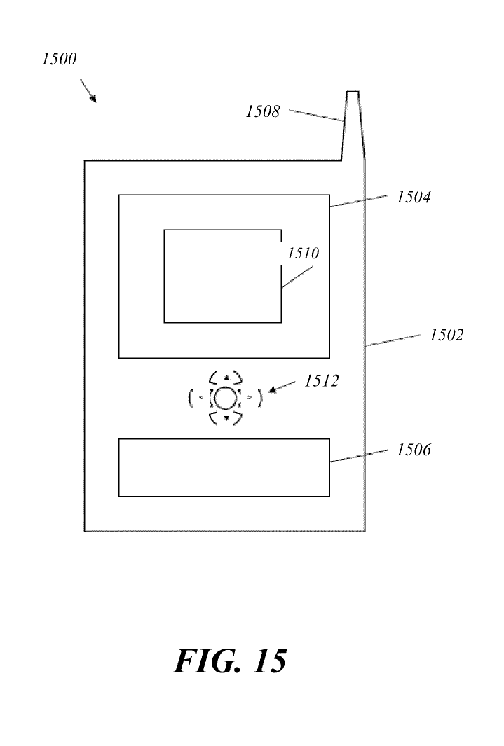

As described above, system 1400 may be embodied in varying physical styles or form factors. FIG. 15 illustrates implementations of a small form factor device 1500 in which system 1500 may be embodied. In various embodiments, for example, device 1500 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 15, device 1500 may include a housing 1502, a display 1504, an input/output (I/O) device 1506, and an antenna 1508. Device 1500 also may include navigation features 1512. Display 1504 may include any suitable display unit for displaying information appropriate for a mobile computing device. I/O device 1506 may include any suitable I/O device for entering information into a mobile computing device. Examples for I/O device 1506 may include an alphanumeric keyboard, a numeric keypad, a touch pad, input keys, buttons, switches, rocker switches, microphones, speakers, voice recognition device and software, and so forth. Information also may be entered into device 1500 by way of microphone (not shown). Such information may be digitized by a voice recognition device (not shown). The embodiments are not limited in this context.

The embodiments, as previously described, may be implemented using various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The following examples pertain to further embodiments.

In example 1, an apparatus for video encoding includes a memory to store a video frame, a processor circuit, and a selective encoding component for execution on the processor circuit to perform selective encoding of the video frame, the selective encoding to classify the video frame into a primary object region and a background region, and encode the primary object region at a first quality level and the background region at a background quality level, the first quality level to comprise a higher quality level than the background quality level.

In example 2, the selective encoding component of example 1 may optionally be for execution on the processor to perform selective encoding when bandwidth falls below a bandwidth threshold.

In example 3, the selective encoding component of any of examples 1-2 may optionally be for execution on the processor to perform a facial recognition procedure for pixels within the video frame and assign facial regions that are identified by the facial recognition procedure as primary object regions.

In example 4, the selective encoding component of any of examples 1-3 may optionally be for execution on the processor to generate a selectively encoded video stream comprising a multiplicity of selectively encoded video frames when a signal indicating low bandwidth is received.

In example 5, the selective encoding component of any of examples 1-4 may optionally be for execution on the processor to receive a user selected pixel region and selectively encode an object within the video frame at the first quality level based upon the user selected pixel region.

In example 6, the selective encoding component of any of examples 1-5 may optionally be for execution on the processor to generate position information that identifies pixel coordinates in a video frame for the primary object region.

In example 7, the selective encoding component of any of examples 1-6 may optionally be for execution on the processor to switch classification as a primary object region from a first region associated with a first object to a second region associated with a second object in the video frame.

In example 8, the selective encoding component of any of examples 1-7 may optionally be for execution on the processor to classify an additional region in the video frame as a secondary object region, and encode the secondary object region at a second quality level less than the first quality level and higher than the background quality level.

In example 9, the primary object region of any of examples 1-8 may optionally include two or more separate regions of the video frame.

In example 10, the selective encoding component of any of examples 1-9 may optionally be for execution on the processor to generate a bitmask that identifies pixels of the data frame corresponding to the background region.

In example 11, the selective encoding component of any of examples 1-10 may optionally be for execution on the processor to perform selective encoding based upon signals indicative of user activity.

In example 12, at least one computer-readable storage medium includes instructions that, when executed, cause a system to perform, responsive to receipt of a video frame, selective encoding of the video frame, the selective encoding to classify the video frame into a primary object region and background region, and encode the primary object region at a first quality level and the background region at a background quality level, the first quality level to comprise a higher quality level than the background quality level.

In example 13, the at least one computer-readable storage medium of example 12 includes instructions that, when executed, cause a system to perform selective encoding when bandwidth falls below a bandwidth threshold.

In example 14, the at least one computer-readable storage medium of any of examples 12-13 includes instructions that, when executed, cause a system to perform a facial recognition procedure for pixels within the video frame and assign facial regions that are identified by the facial recognition procedure as primary object regions.

In example 15, the at least one computer-readable storage medium of any of examples 12-14 includes instructions that, when executed, cause a system to generate a selectively encoded video stream comprising a multiplicity of selectively encoded video frames when a signal indicating low bandwidth is received.

In example 16, the at least one computer-readable storage medium of any of examples 12-15 includes instructions that, when executed, cause a system to receive a user selected pixel region and selectively encode an object within the video frame at the first quality level based upon the user selected pixel region.

In example 17, the at least one computer-readable storage medium of any of examples 12-16 includes instructions that, when executed, cause a system to generate position information that identifies pixel coordinates in a video frame for the primary object region.

In example 18, the at least one computer-readable storage medium of any of examples 12-17 includes instructions that, when executed, cause a system to classify an additional a region in the video frame as a secondary object region, and encode the secondary object region at a second quality level less than the first quality level and higher than the background quality level.

In example 19 a method to encode video includes responsive to receipt of a video frame, performing selective encoding of the video frame, the selective encoding comprising classifying the video frame into a primary object region and background region; encoding the primary object region at a first quality level; and encoding background regions of the video frame at a background quality level less than the first quality level.

In example 20 the method of example 19 includes performing selective encoding when bandwidth falls below a bandwidth threshold.

In example 21 the method of any of examples 19-20 includes performing a facial recognition procedure for pixels within the video frame and assign facial regions that are identified by the facial recognition procedure as primary object regions.

In example 22 the method of any of examples 19-21 includes generating position information that identifies pixel coordinates in a video frame for the primary object region.

In example 23 the method of any of examples 19-22 includes classifying an additional a region in the video frame as a secondary object region, and encoding the secondary object region at a second quality level less than the first quality level and higher than the background quality level.

In example 24, a system for transmitting encoded video includes a memory to store a video frame; a processor; and a selective encoding component for execution on the processor to perform selective encoding of the video frame. The selective encoding comprises classifying a region in the video frame as a primary object region, and encoding the primary object region at a first quality level higher than a background quality level for encoding of background regions of the video frame, the background regions comprising regions that are outside the primary object region; and an interface to transmit the video frame after the selective encoding.

In example 25, the selective encoding component of example 24 may be for execution on the processor to perform selective encoding when bandwidth for transmitting video frames falls below a bandwidth threshold.

In example 26, the selective encoding component of any of examples 24-25 may be for execution on the processor to perform a facial recognition procedure for pixels within the video frame and assign facial regions that are identified by the facial recognition procedure as primary object regions.

In example 27, the selective encoding component of any of examples 24-26 may be for execution on the processor to generate a selectively encoded video stream comprising a multiplicity of selectively encoded video frames when a signal indicating low bandwidth is received.

In example 28, the selective encoding component of any of examples 24-27 may be for execution on the processor to receive a user selected pixel region and selectively encode an object within the video frame at the first quality level based upon the user selected pixel region.

In example 29, the selective encoding component of any of examples 24-28 may be for execution on the processor to generate position information that identifies pixel coordinates in a video frame for the primary object region.

In example 30, the selective encoding component of any of examples 24-29 may be for execution on the processor to switch classification as a primary object region from a first region associated with a first object to a second region associated with a second object in the video frame.

In example 31, the selective encoding component of any of examples 24-30 may be for execution on the processor to classify an additional region in the video frame as a secondary object region, and encode the secondary object region at a second quality level less than the first quality level and higher than the background quality level.

In example 32, primary object region of any of examples 24-31 may include two or more separate regions of the video frame.

In example 33, the selective encoding component of any of examples 24-32 may be for execution on the processor to perform selective encoding based upon signals indicative of user activity.

In some embodiments, an element is defined as a specific structure performing one or more operations. It may be appreciated, however, that any element defined as a specific structure performing a specific function may be expressed as a means or step for performing the specified function without the recital of structure, material, or acts in support thereof, and such means or step is meant to cover the corresponding structure, material, or acts described in the detailed description and equivalents thereof. The embodiments are not limited in this context.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a memory to store a video frame;
a processor circuit; and
a selective encoding component for execution on the processor circuit to perform selective encoding of the video frame, the selective encoding to classify the video frame into a primary object region and a background region, and encode the primary object region at a first quality level and the background region at a background quality level, the first quality level to comprise a higher quality level than the background quality level.

2. The apparatus of claim 1, the selective encoding component for execution on the processor to perform selective encoding when bandwidth falls below a bandwidth threshold.

3. The apparatus of claim 1, the selective encoding component for execution on the processor to perform a facial recognition procedure for pixels within the video frame and assign facial regions that are identified by the facial recognition procedure as primary object regions.

4. The apparatus of claim 1, the selective encoding component for execution on the processor to generate a selectively encoded video stream comprising a multiplicity of selectively encoded video frames when a signal indicating low bandwidth is received.

5. The apparatus of claim 1, the selective encoding component for execution on the processor to receive a user selected pixel region and selectively encode an object within the video frame at the first quality level based upon the user selected pixel region.

6. The apparatus of claim 1, the selective encoding component for execution on the processor to generate position information that identifies pixel coordinates in a video frame for the primary object region.

7. The apparatus of claim 1, the selective encoding component for execution on the processor to switch classification as a primary object region from a first region associated with a first object to a second region associated with a second object in the video frame.

8. The apparatus of claim 1, the selective encoding component for execution on the processor to classify an additional region in the video frame as a secondary object region, and encode the secondary object region at a second quality level less than the first quality level and higher than the background quality level.

9. The apparatus of claim 1, the primary object region comprising two or more separate regions of the video frame.

10. The apparatus of claim 1, the selective encoding component for execution on the processor to generate a bitmask that identifies pixels of the data frame corresponding to the background region.

11. The apparatus of claim 1, the selective encoding component for execution on the processor to perform selective encoding based upon signals indicative of user activity.

12. At least one computer-readable storage medium comprising instructions that, when executed, cause a system to perform, responsive to receipt of a video frame, selective encoding of the video frame, the selective encoding to classify the video frame into a primary object region and background region, and encode the primary object region at a first quality level and the background region at a background quality level, the first quality level to comprise a higher quality level than the background quality level.

13. The at least one computer-readable storage medium of claim 12 comprising instructions that, when executed, cause a system to perform selective encoding when bandwidth falls below a bandwidth threshold.

14. The at least one computer-readable storage medium of claim 12 comprising instructions that, when executed, cause a system to perform a facial recognition procedure for pixels within the video frame and assign facial regions that are identified by the facial recognition procedure as primary object regions.

15. The at least one computer-readable storage medium of claim 12 comprising instructions that, when executed, cause a system to generate a selectively encoded video stream comprising a multiplicity of selectively encoded video frames when a signal indicating low bandwidth is received.

16. The at least one computer-readable storage medium of claim 12 comprising instructions that, when executed, cause a system to receive a user selected pixel region and selectively encode an object within the video frame at the first quality level based upon the user selected pixel region.

17. The at least one computer-readable storage medium of claim 12 comprising instructions that, when executed, cause a system to generate position information that identifies pixel coordinates in a video frame for the primary object region.

18. The at least one computer-readable storage medium of claim 12 comprising instructions that, when executed, cause a system to classify an additional a region in the video frame as a secondary object region, and encode the secondary object region at a second quality level less than the first quality level and higher than the background quality level.

19. A method, comprising:
responsive to receipt of a video frame, performing selective encoding of the video frame, the selective encoding comprising:
classifying the video frame into a primary object region and background region;
encoding the primary object region at a first quality level; and
encoding background regions of the video frame at a background quality level less than the first quality level.

20. The method of claim 19, comprising performing selective encoding when bandwidth falls below a bandwidth threshold.

21. The method of claim 19, comprising performing a facial recognition procedure for pixels within the video frame and assign facial regions that are identified by the facial recognition procedure as primary object regions.

22. The method of claim 19, comprising generating position information that identifies pixel coordinates in a video frame for the primary object region.

23. The method of claim 19, comprising classifying an additional a region in the video frame as a secondary object region, and encoding the secondary object region at a second quality level less than the first quality level and higher than the background quality level.
